(19) United States
(12) Patent Application Publication
(10) Pub. No.: US 2004/0232143 A1
(43) Pub. Date: Nov. 25, 2004

(54) Eared metal food-heating tray for microwave oven

(75) Inventor: C. J. Zhu, Bao An (CN)

Correspondence Address: CHRISTIE, PARKER & HALE, LLP, PO BOX 7068, PASADENA, CA, 91109-7068, US

(73) Assignee: Jinda Plastic Metal Products (Shenzhen) Co., Ltd.

(21) Appl. No.: 10/876,902

(22) Filed: Jun. 24, 2004

Related U.S. Application Data
(62) Division of application No. 10/167,876, filed on Jun. 10, 2002.

(30) Foreign Application Priority Data
Aug. 10, 2001 (CN) 01233932.6

(51) Int. Cl. H05B 6/80; H05B 6/50

(52) U.S. Cl. 219/732; 219/730

(57) ABSTRACT

A kind of metal food-heating tray for microwave oven that comprising a metal tray, characterized in that insulating ears are symmetrically distributed on the edge of the metal tray. The eared metal food-heating tray for microwave oven in this utility model is scientific in design and reasonable in structure. The insulating ears on two sides of the tray can make the operation and utilization of metal tray more convenient and thereby the tray can be taken with hand regardless of the high temperature of the foods in the tray and the hotness of the tray itself. In order to make the metal food-heating tray applicable to microwave oven-used rotating trays made of different materials, insulating stands may be evenly distributed on the bottom surface of the eared metal food-heating tray for microwave oven in this utility model.

### CROSS REFERENCE TO RELATED APPLICATION

This application is a divisional of U.S. patent application Ser. No. 10/167,876, filed on Jun. 10, 2004, which claims priority of Chinese Patent Application No. 01233932.6, filed on Aug. 10, 2001.

### TECHNICAL FIELD

The present utility model relates to a tray of microwave oven, especially a kind of eared metal food-heating tray for microwave oven.

### BACKGROUND TECHNOLOGY

As a new type of food heater, the microwave oven has been widely used among the consumers. The conventional rotating trays used in microwave ovens are made of glass to facilitate penetration of microwave. Therefore, non-metal trays are generally used for heating foods in the microwave oven. Said non-metal trays are generally thick glass trays or ceramic trays. With the advancement of researches on the heating principle of microwave oven, microwave oven rotating trays made of metallic materials have been put on the market, such as metal enamel rotating trays that are characterized by light weight and strong durability, and can fully satisfy the requirement of application as an auxiliary part of microwave oven in performance. Now that microwave oven can use metal enamel rotating tray, it's undoubted that metal tray can be used for containing foods. Therefore, metal food-heating trays for microwave oven have appeared in the market. Metal food-heating trays are advantageous because they are thinner, more compact, less fragile, and easier to clean. However, because of quick heat conduction, the metal tray may burn hand when it is taken out of the oven.

### CONTENT OF THE INVENTION

The present utility model eliminates the aforementioned defect of the metal food-heating tray by providing a kind of eared metal food-heating tray for microwave oven that is reasonable in structure and convenient for use.

The eared metal food-heating tray for microwave oven in the present utility model comprises a metal tray, characterizing insulating ears symmetrically distributed on the edge of the metal tray.

The eared metal food-heating tray for microwave oven in the present utility model is scientific in design and reasonable in structure. The insulating ears on two sides of the tray can make the operation and utilization of metal tray more convenient and thereby the tray can be taken with hand regardless of the high temperature of the foods in the tray and the hotness of the tray itself. In order the make the metal food-heating tray applicable to microwave oven-used rotating trays made of different materials, insulating stands may be evenly distributed on the bottom surface of the eared metal food-heating tray for microwave oven in this utility model.

The particular structure of the eared metal food-heating tray for microwave oven in this utility model are as shown in the following drawings and embodiment.

### BRIEF DESCRIPTION OF THE DRAWINGS

FIG. 1: Structural schematic drawing of eared metal food-heating tray for microwave oven;

FIG. 2: Sectional view of the eared metal food-heating tray for microwave oven as shown in line A-A of Figure.

### THE OPTIMUM EMBODIMENT

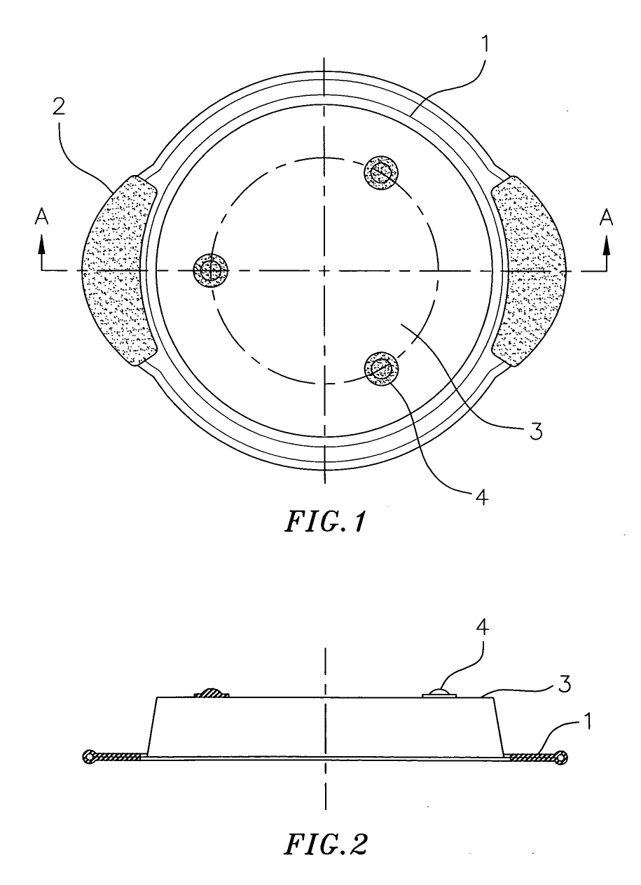

From FIG. 1 and FIG. 2, It is clearly shown that this is a circular metal food-heating tray; insulating ears 2 are symmetrically distributed on the edge of metal tray 1; there are insulating stands 4 on the bottom surface 3 of the metal tray 1; the insulating stands 4 are symmetrically distributed on the bottom surface 3 of the metal tray 1; the insulating ears 2 and the insulating stands 4 are stuck on the metal tray 1 through vulcanization. The said insulating ears 2 and the insulating stands 4 are made by rubber.

What is claimed is:

1. A food-heating system comprising:
a microwave oven having a metal rotating plate;
a metal tray comprising a receptacle portion for receiving a food to be heated and a lip portion extending from the receptacle portion;
a plurality of insulating stands evenly distributed on a bottom surface of the receptacle portion of the metal tray, wherein each insulating stand has a top surface and a bottom surface, such that the top surface of each insulating stand is fixedly attached directly to the bottom surface of the receptacle portion of the metal tray, and wherein the bottom surface of each insulating stand is disposed directly in contact with the metal rotating plate; and
a plurality of insulating ears fixedly attached to the lip portion of the metal tray.

2. The food-heating system as recited in claim 1, wherein each of the plurality of insulating ears is non-removably attached to the lip portion of the metal tray.

3. The food-heating system as recited in claim 1, wherein the lip portion of the metal tray comprises a plurality of handles for ease of lifting the metal tray, and wherein each of the plurality of insulating ears is fixedly attached to a corresponding one of the plurality of handles.

4. The food-heating system as recited in claim 1, wherein the insulating ears and the insulating stands each comprise rubber.

5. The food-heating system as recited in claim 4, wherein the insulating ears and the insulating stands are each attached to the metal tray through vulcanization.

6. The food-heating system as recited in claim 1, wherein the top surface of each insulating stand is non-moveably and fixedly attached directly to the bottom surface of the metal tray.

7. The food-heating system as recited in claim 1, wherein the plurality of insulating stands comprises three insulating stands that are symmetrically distributed on the bottom surface of the metal tray.

8. The food-heating system as recited in claim 1, wherein the plurality of insulating ears comprises two insulating ears symmetrically distributed about the lip portion of the metal tray.

9. The food-heating system as recited in claim 8, wherein each of the plurality of insulating ears are substantially aligned with a corresponding one of the plurality of insulating ears along an axis of the metal tray.

10. A method of heating food comprising:
providing a microwave oven having a metal rotating plate;
providing a metal tray comprising a receptacle portion for receiving a food to be heated and a lip portion extending from the receptacle portion;
providing a plurality of insulating stands, wherein each insulating stand has a top surface and a bottom surface;
fixedly attaching the top surface of each insulating stand directly to a bottom surface of the receptacle portion of the metal tray;
placing the bottom surface of each insulating stand in direct contact with the metal rotating plate;
providing a plurality of insulating ears;
fixedly attaching each of the plurality of ears to the lip portion of the metal tray; and
activating the microwave oven to heat the food.

11. The method of claim 10, further comprising non-removably attaching each of the plurality of insulating ears to the lip portion of the metal tray.

12. The method of claim 10, further comprising forming a plurality of handles on the lip portion of the metal tray for ease of lifting the metal tray, and fixedly attaching each of the plurality of insulating ears to a corresponding one of the plurality of handles.

13. The method of claim 10, further comprising forming the insulating ears and the insulating stands from a rubber material.

14. The method of claim 13, further comprising attaching the insulating ears and the insulating stands to the metal tray through vulcanization.

15. The method of claim 10, further comprising non-moveably and fixedly attaching the top surface of each insulating stand directly to the bottom surface of the metal tray.

16. The method of claim 10, wherein the plurality of insulating stands consists of three insulating stands that are symmetrically distributed on the bottom surface of the metal tray.

17. The method of claim 10, wherein the plurality of insulating ears comprises two insulating ears symmetrically distributed about the lip portion of the metal tray.

18. The method of claim 17, wherein each of the plurality of insulating ears are substantially aligned with a corresponding one of the plurality of insulating ears along an axis of the metal tray.
